(19) United States
(12) Patent Application Publication
(10) Pub. No.: US 2007/0217414 A1
(43) Pub. Date: Sep. 20, 2007

(54) System and method for multicasting over power lines

(76) Inventors: William H. Berkman, New York, NY (US); Henry N. Tran, Gaithersburg, MD (US)

Correspondence Address: CAPITAL LEGAL GROUP, LLC, 5323 POOKS HILL ROAD, BETHESDA, MD, 20814, US

(21) Appl. No.: 11/374,205

(22) Filed: Mar. 14, 2006

(51) Int. Cl. H04L 12/56

(52) U.S. Cl. 370/390; 370/432

(57) ABSTRACT

A method of communicating over a power line communications system is provided. Data is received into a power line communication system (PLCS). The downstream data may be transmitted along a medium voltage power line in one or more multicast packets to a plurality of devices. Along pathways for transmitting the downstream data toward one or more user devices, multicast packets may be repeated or reformed. In some embodiments, a device may package the data in a unicast packet for transmission along a portion of the pathway. Along the pathways for upstream transmission data from one or more user devices, unicast packets may be transmitted. Wireless links, low voltage power line links, or other wired links are established for delivering multicast packets to and unicast packets from user devices located among the subscribers' premises.

### FIELD OF THE INVENTION

The present invention generally relates to methods and systems of power line communication, and more particularly to a method of multicasting in a power line communication system.

### BACKGROUND OF THE INVENTION

A power line communication system (PLCS) uses the infrastructure of existing power distributions systems to form a communication network. Well-established power distribution systems exist throughout most of the United States, and other countries providing power to customers via power lines. With some modification, the infrastructure of the existing power distribution system can be used to provide data communication, in addition to conventional power delivery. In other words, existing power lines that already have been run to many homes and offices can be used to carry data signals to and from those homes and offices. These data signals are communicated on and off the power lines at various points in the power line communication system, such as, for example, near homes, offices, IP network service providers, and the like.

By linking a power line communication system into a global information network, such as the internet, many communication and information services become available to PLCS end users. Accordingly, a PLCS may include an interface to the conventional telecommunications network, such as through a point of presence (POP) for the internet.

As end user services delivered over the global information network proliferate, the amount of data and data ‘traffic’ increases. Accordingly, there is a challenge in allocating the physical communication resources to carry the data and manage the data traffic.

Various embodiments of the present invention may address these challenges and offer advantages over conventional PLCS systems.

### SUMMARY OF THE INVENTION

The present invention is directed to a method of communication in a power line communication system. In one embodiment, the data is transmitted in a multicast transmission over a low voltage power line to a plurality of devices, which may be user devices. Data may also be multicast over a medium voltage power line to receiving devices such as bypass devices. Further, some embodiments may be configured to provide broadcast transmission. Unicast transmission may be used for upstream communications and links where multicast transmissions may not offer improved network conditions.

The invention will be better understood by reference to the following detailed description taken in conjunction with the accompanying drawings.

### BRIEF DESCRIPTION OF THE DRAWINGS

The invention is further described in the detailed description that follows, by reference to the noted drawings by way of non-limiting illustrative embodiments of the invention, in which like reference numerals represent similar parts throughout the drawings. As should be understood, however, the invention is not limited to the precise arrangements and instrumentalities shown. In the drawings:

FIG. 1 is a diagram of an exemplary overhead power distribution system;

FIG. 2 is a block diagram of a portion of an example power line communication system (PLCS);

FIG. 3 is a network diagram of a portion of a PLCS illustrating multiple unicast transmissions;

FIG. 4 is a network diagram of a portion of a PLCS illustrating a multicast transmission;

FIG. 5 is a flow chart of a power line server process for determining routing paths in an example PLCS;

FIG. 6 is a block diagram of functional processes performed by a bypass device or other node;

FIG. 7 is a network diagram of a portion of the PLCS illustrating an example embodiment of the present invention;

FIG. 8 is a block diagram of an example embodiment of a backhaul point; and

FIG. 9 is a block diagram of an example embodiment of a bypass device.

### DETAILED DESCRIPTION OF ILLUSTRATIVE EMBODIMENTS

In the following description, for purposes of explanation and not limitation, specific details are set forth, such as particular networks, communication systems, computers, PLCS, terminals, devices, components, techniques, data and network protocols, software products and systems, operating systems, development interfaces, hardware, etc. in order to provide a thorough understanding of the present invention.

However, it will be apparent to one skilled in the art that the present invention may be practiced in other embodiments that depart from these specific details. Detailed descriptions of well-known networks, communication systems, computers, PLCS, terminals, devices, components, techniques, data and network protocols, software products and systems, operating systems, development interfaces, and hardware are omitted so as not to obscure the description of the present invention.

Host System Architecture and General Design Concepts

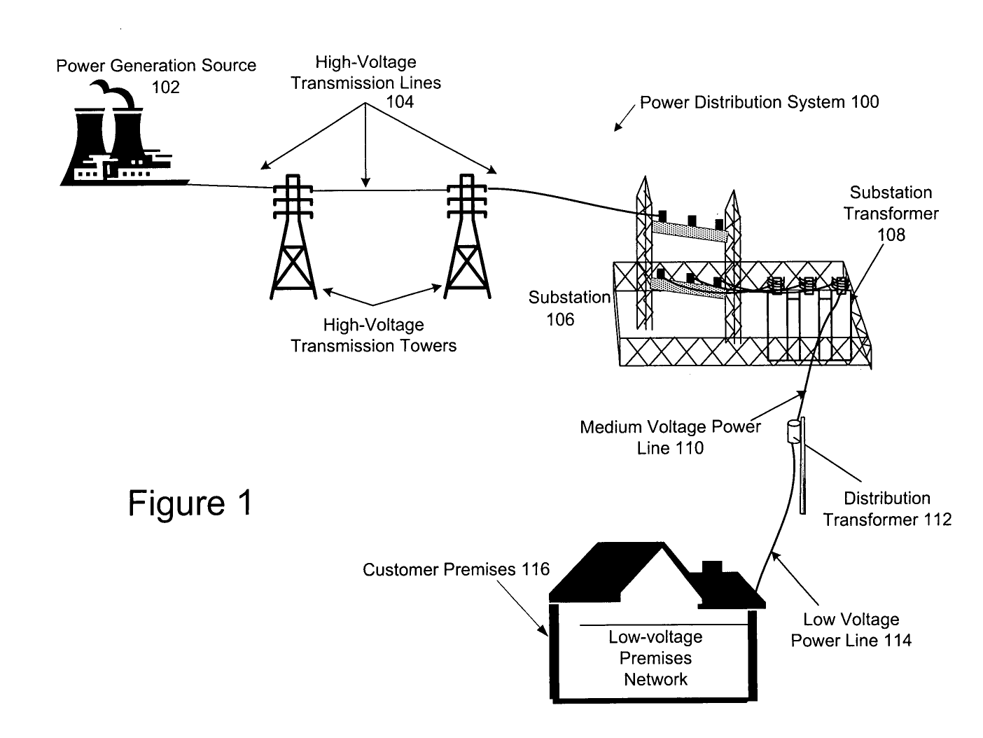

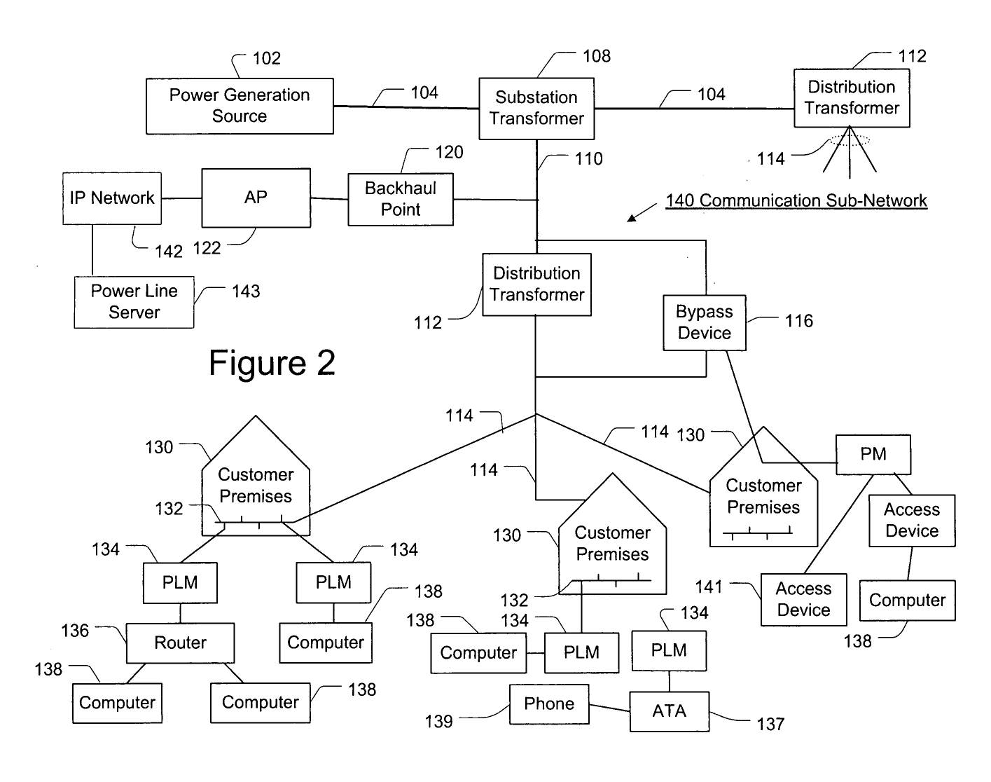

The method of communicating over a medium voltage power line is implemented by a power line communication system (PLCS). The PLCS uses parts of a power distribution system. FIG. 1 illustrates an example power distribution system 100. FIG. 2 illustrates an example power line communication system for hosting the communication method.

The power distribution system 100 is part of a power grid infrastructure, including power generation sources, power transmission components, and power distribution components. Power is generated at a power generation source 102, which typically generates power as high as 25 kilo-volts (kV). A transmission substation (not shown), typically located near a corresponding power generation source, increases the generated voltage to a desired high voltage for transmission along high voltage (HV) transmission lines 104. Typical voltages found on HV transmission lines 104 range from 69 kV to in excess of 800 kV. Power is transmitted over the power grid along the HV transmission lines 104.

Switching substations (not shown) are located along the grid to route the high voltage power line transmissions from one portion of the power grid to another portion. Distribution substations 106 receive the high voltage power line transmissions and reduce the high level power voltages to medium level power voltages. More specifically, the distribution substation 106 includes a substation transformer 108 which converts the high level power voltages to the medium level power voltages. The substation transformer 108 has a primary side for connection to a first voltage (e.g., a high voltage section) and a secondary side for outputting another voltage (e.g., a medium voltage section). Medium voltage (MV) power lines 110 distribute the medium level power voltages to a region or local area. Typical voltage levels on the MV power lines 108 range from about 1000 V to about 100 kV.

To distribute power at the low level voltages that are required at customer premises 116, the MV power lines 110 extend to multiple distribution transformers 112. A distribution transformer 112 steps down the medium level power voltages to the requisite lower level voltages. The distribution transformers 112 have a primary side for connection to a first voltage (e.g., the medium voltage section) and a secondary side for outputting another voltage (e.g., the low voltage section). The substation transformers 108 and distribution transformers 112 also are referred to as step-down transformers. Low voltage (LV) power lines 114 carry the low level power voltages to households and other types of customer premises 116. Typical voltage levels on LV power lines 110 typically range from about 100 V to about 240 V.

Distribution transformers 112 distribute low level power signals to the end user facilities as one, two, three, or more phased power signals, depending upon the demands of the end user. In the United States, for example, the local distribution transformers typically feed anywhere from one to ten homes, depending upon the concentration of the customer premises in a particular area. In Europe the medium level voltages and low level voltages typically are higher than those used in the United States and Canada. As a result, the distribution transformers included in the European power grid infrastructure typically serve an entire neighborhood. In various embodiments distribution transformers are pole-top transformers located on a utility pole, pad-mounted transformers located on the ground, or transformers located under ground level.

Host Power Line Communication System

An example of one portion of an overhead power line communication system (PLCS) is shown in FIG. 2, including multiple distribution transformers 112, MV power lines 110, LV power lines 114, and multiple communication nodes 116, 120. Communications are received into the PLCS from an external communications network at a first type of communication node referred to as a backhaul point 120. Communications flow within the PLCS between communication nodes over medium voltage power lines, and in some instances over low voltage power lines. Communications with end user devices may occur through another type of communication node referred to as a bypass device 116. Communications occur in both directions with data being transmitted from outside the PLCS to end user devices, and data being transmitted upstream into the PLCS from end user devices.

A communication node typically includes an MV access device. For clarity, an MV access device includes any device physically coupled to a MV power line including but not limited to a backhaul point 120, a bypass device 116, and an MV repeater.

The backhaul point 120 serves as an interface and gateway between the power line and a non-power line telecommunications network. One or more backhaul points 120 typically are communicatively coupled to an aggregation point (AP) 122 that may be coupled to (or form part of) a point of presence (POP) to an IP network (e.g., the Internet). The backhaul point 120 may be connected to the AP 122, directly or indirectly, using any available mechanism.

Information entering the sub-network 140 destined to a user device is received at the backhaul point 120, then communicated along the MV power lines 110 to one or more bypass devices 116. A given bypass device 116 transmits the data to one or more customer premises 130. The bypass device 116 maintains the communication link with user devices at one or more customer premises 130. For clarity, the term “bypass device” is used herein to refer to a device that may provide communications between the MV power line and one or more user devices, routers, electronic meters or other devices and is not limited to a device that is coupled to both the MV and LV power lines. A communication link may be established between the bypass device 116 and an end user device using a power line, wired (e.g., coaxial cable, DSL, fiber optic cable) or wireless communication link.

The bypass devices 116 provide communication services for user devices (e.g., routers 136, computers 138, telephone adapters 137, phones 139, and other types of user devices). Typically a modem at the subscriber premises 130 links the user devices to the bypass device 116. Exemplary communication services provided by a bypass device 116, include: security management; IP network protocol (IP) packet routing; data filtering; access control; service level monitoring; service level management; signal processing; and modulation/demodulation of signals transmitted over the power lines 110. In FIG. 2, only one bypass device 116 is depicted. However, in practice five, ten, or more communications devices may form part of a single PLCS subnet.

Information entering the sub-network 140 from user devices may be received at a bypass device 116, then communicated along the MV power lines 110 to the backhaul point 120 for communication out of the sub-network 140 to the IP network 142.

At the user end of the PLCS, data flow terminates or originates from a user device. The user device is coupled to a premises modem 135, such as a power line modem, wireless modem, cable modem or other suitable transceiver modem. For a link through a power line modem 134, signals travel over electrical circuits at the subscriber premises. Specifically, various electrical circuits within the customer's premises distribute power and data signals over a premises power line network 132. The customer draws power on demand by plugging a device into a power outlet. In a similar manner, the customer may plug the power line modem (PLM) 134 into a power outlet to digitally connect user devices to communicate data signals carried by the power wiring. The PLM 134 thus serves as an interface for user devices to access the PLCS.

The backhaul point 120 is linked to an aggregation point (AP) 122 or another upstream node ultimately linking to an external communication network. The aggregation point 122 typically includes an Internet Protocol (IP) network data packet router and is connected to an IP network backbone, thereby providing access to the IP network 142 (and may be a POP). Alternatively, the AP 122 may be connected to a POP, which provides access to the IP network, or another communication network. In various embodiments, the backhaul point 120 is coupled to the AP 122 using a wired or wireless communication link. For example, any of several available coupling media are used to link the backhaul point 120 and the AP 122, including fiber optic conductors, T-carrier, Synchronous Optical Network (SONET), and wireless techniques.

In some areas a plurality of aggregation points are connected to a POP which provides access to the IP network. The POP (or AP as the case may be) may be capable of routing voice and general data traffic to and from a particular IP network. The routing of packets is determined by any suitable means such as by including information in the data packets to determine whether a packet is voice. The IP network typically handles voice and data packets differently, so as to meet the latency requirements for voice packets.

In yet another embodiment, multiple backhaul points 120 communicate with one aggregation point. A plurality of backhaul points 120 may be connected to a distribution point and the distribution points may be coupled to the AP 122, which provides access to the IP network 142 and other networks.

Some embodiments include multiple distribution points, in which a plurality of backhaul points 120 communicate with a given distribution point. A backhaul point 120 can communicate with a distribution point. Each group of distribution points may communicate with a corresponding AP 122.

As described above, wireless links may be implemented between an AP 122 and a backhaul point 120, and between a premises modem and a bypass device 116. Wireless communication occurs using protocols substantially conforming to the IEEE 802.16 standards, multipoint microwave distribution system (MMDS) standards, IEEE 802.11a, b, or g standards, DOCSIS (Data Over Cable System Interface Specification) signal standards, or another suitable signal set. The wireless links may use any suitable frequency band. In one example, frequency bands are used that are selected from among ranges of licensed frequency bands (e.g., 6 GHz, 11 GHz, 18 GHz, 23 GHz, 24 GHz, 28 GHz, or 38 GHz band) and unlicensed frequency bands (e.g., 900 MHz, 2.4 GHz, 5.8 Ghz, 24 GHz, 38 GHz, or 60 GHz (i.e., 57-64 GHz)).

In some embodiments a power line server 143 is linked to the PLCS sub-network 140, either directly or through the IP network 142. The power line server (PLS) 143 is a computer system with memory for storing executable program code and database of information about the sub-network 140.

Additional details of the PLS 143 are described below in a separate section. Additional details of the MV access devices also are described below in a separate section. A detailed description of an example PLCS, its components and features is provided in U.S. patent application Ser. No. 11/091,677 filed Mar. 28, 2005, Attorney Docket No. CRNT-0239, entitled “Power Line Repeater System and Method,” which is hereby incorporated by reference in its entirety. A detailed description of another example PLCS, its components and features is provided in U.S. patent application Ser. No. 10/973,493 filed Oct. 26, 2004, Attorney Docket No. CRNT-0229, entitled “Power Line Communications System and Method of Operating the Same,” which is hereby incorporated by reference in its entirety. The present invention may be used with power line communication (PLC) networks as described in the above patent applications such as overhead and underground power line communications systems. Thus, the invention is not limited to a particular PLCS, PLCS architecture, backhaul link, topology, data types, data services, or application.

Multicasting Over Power Lines

Data from IP network 142 may be received at a backhaul point 120. The backhaul point 120 transmits the data to other communication nodes in sub-network 140 using any of several methodologies, including unicasting, broadcasting, multicasting and/or another suitable methodology. Each bypass device 116 receiving the data may transmit the data to other communication nodes or user devices in its in sub-network using any of several methodologies, including unicasting, broadcasting, multicasting and/or another suitable methodology. Ultimately the data arrives at the destination address(es) indicated in the packet header. Data transmitted out of the PLCS sub-network 140 typically originates at a user device and is transmitted to a bypass device 116 and along MV power lines 110 to the backhaul point 120. The backhaul point 120 transmits the data to the IP network 142 for delivery to its destination outside the PLCS sub-network 140. The bypass devices 116 typically transmit the transmitted data packets upstream using a unicast methodology.

For a unicast transmission, a communication node (e.g., the backhaul point, repeater or bypass device) identifies which communication node is to receive the data packet in order to continue transmission of the data packet to the final destination address. For example, during a unicasting downstream transmission (toward a user device), the backhaul point 120 transmits the data packet to a selected bypass device 116, which in turn performs a similar operation sending the data packet to a next communication node. Thus, typically the data packet is transmitted along a single path to its destination address—(e.g., an end user device). Similarly for a unicasting upstream transmission, a bypass device 116 receives and transmits the data packet to a selected upstream device (e.g., a backhaul point 120 or a bypass device 116 acting as an MV repeater), which in turn performs a similar operation sending the data packet to its next communication node. Ultimately the data packet reaches the backhaul point 120, which then transmits the data to the AP 122 and out of the PLCS sub-network 140. Unicast transmissions may be accomplished by inserting in the data packet the MAC (or IP) address of the next hop (i.e., the node that should next receive the data packet) in route to the destination.

For a downstream broadcast transmission, the backhaul point 120 transmits the data packet(s) to every downstream communication node with which it is in communication. Thus, every communication node directly linked to the backhaul point 120 through the medium voltage power lines 110 receives the data packet(s). Each bypass device 116, for example, may receive the data packet(s) may then transmit the data packet(s) to every downstream communication node.

For a multicast downstream transmission from backhaul point 120, the data packet(s) is transmitted to a select group of downstream communication nodes, which in turn transmit the data packet(s) to a select group of downstream communication nodes along a path to any of the downstream destinations. Multicasting may overcome the challenge of providing data intensive services to end users over a delivery medium having a limited bandwidth. Multicasting may also reduce latency in the network. As the demand for video and audio data streams by end users increases, the amount of data traversing the PLCS sub-network 140 increases. However, there is a limited bandwidth that can be provided by the power lines and other communication links within the PLCS sub-network 140. In one embodiment, multicasting allows a single data stream to be routed along the communication nodes, with the data stream being duplicated preferably only when the path splits to deliver the data to end users along different paths.

Multicasting, as used herein, refers to the delivery of information to a select group of destinations. The select group may be formed by destination devices (e.g., user devices) that have communicated an interest to receive a particular data stream, who are designated to receive it, and/or via any other group. In many instances, this group need not have any physical or geographical boundaries. Requests to join a group may be granted or denied (e.g., by the bypass device, backhaul point, power line server, or other remote computer configured to respond to such requests). The destinations can be located anywhere within the PLCS sub-network 140 or anywhere else having access to a global communication network (e.g., the internet). Generally, the destination devices join the group, multicast routing is mapped, and the data stream is transmitted.

Multicast routing may use an enhancing or optimizing strategy to deliver the data stream. In a one scenario, data packets are transmitted over a given path of the sub-network 140, preferably only once, with a copy of the data stream only being duplicated (transmitted twice by a node) when the path to the destinations split. Multicasting refers to sending a message to a select group or a subset of everyone on the network, whereas broadcasting generally refers to sending a message to everyone connected to a network who can receive the message. By comparison with multicast, unicast is the conventional point-to-single-point delivery from a single sender to a single destination.

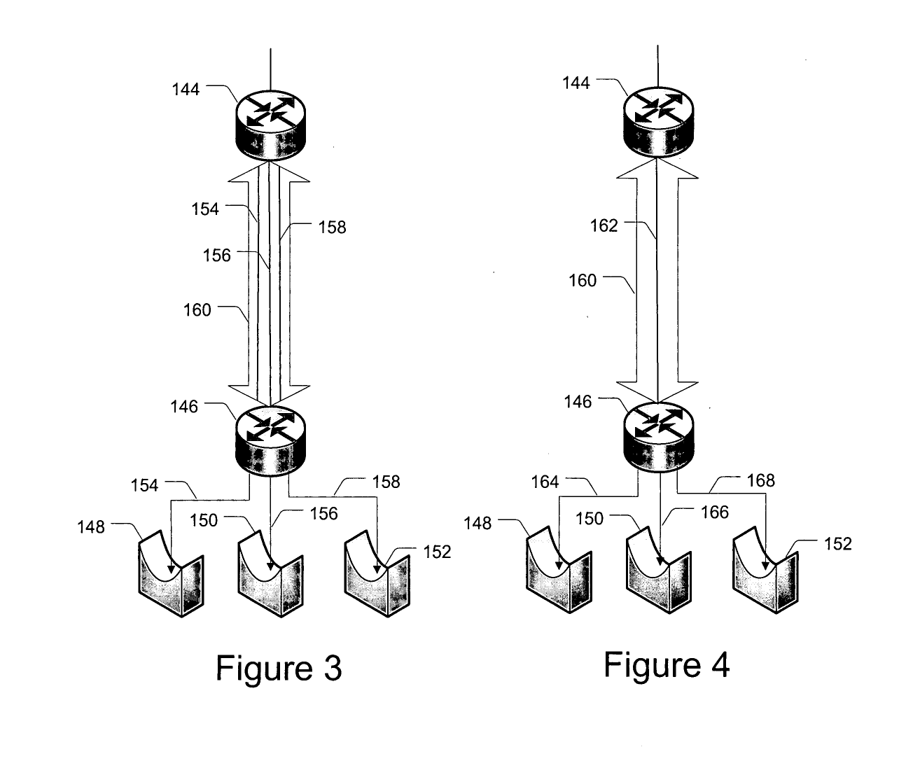

Multicasting methodologies may deliver source traffic to multiple destinations using less network bandwidth than alternative delivery protocols, such as unicasting. Unicasting, for example, requires the source to send an individual “copy” of the data to each destination, which takes time and may require other devices on the network to wait and uses up bandwidth. FIG. 3 shows two exemplary communication nodes 144, 146 in the communication sub-network 140. Consider a scenario where three user devices 148, 150, 152 request a specific data stream. For a unicast methodology there is a separate data stream transmission 154, 156, 158 for each user device. As a result, for all links 160 along the pathway between communication nodes 144, 146 serving the three user devices there are three data streams 154, 156, 158 of the same user content. When there are many destinations to receive the data stream, many identical data streams may be traversing the same communication paths on route to the thousands of destinations. In such a scenario, even a low-bandwidth application may be benefited by multicasting. For a high-bandwidth application, such as MPEG video, a large portion of the available network bandwidth may be needed for a single or few data streams, which may make these data intensive applications unfeasible in many networks without multicasting.

FIG. 4 shows the same communication nodes 144, 146 and user devices 148, 150, 152. Consider a new scenario where the three user devices 148, 150, 152 join a multicast group. One multicast data stream 162 is sent along the common path 160 between nodes 144, 146. The path 160 may include many communication nodes and communication links. When the path splits to serve the differing user devices 148, 150, 152 the data stream is duplicated. Ultimately there are 3 copies 164, 166, 168—one for each user device. If node 146 were a bypass device 116 connected to user device 148, 150, and 152 (e.g., via a LV power line), a single multicast transmission could be transmitted from the bypass device 116 and received by user devices 148, 150, and 152. Thus, along much of the sub-network 140, a single multicast transmission may be used. Accordingly, by using multicasting over the medium voltage power lines 110 and LV power lines 114, data-intensive information services may be delivered to user devices in an efficient and economical manner.

According to an embodiment, the multicasting methodology is implemented at layer 2 (data link) and layer 3 (network) of the PLCS sub-network 140, within a 7-layer open system interconnection model. At the layer 3 level, the devices and software implement switching and routing technologies, and create logical paths, known as virtual circuits, for transmitting data from node to node. Routing and forwarding are functions of layer 3, as well as addressing, internetworking, error handling, congestion control and packet sequencing. Layer 2 activities include encoding and decoding data packets and handling errors in the physical layer, along with flow control and frame synchronization. The data link layer is divided into two sublayers, which include the Media Access Control (MAC) layer and the Logical Link Control (LLC) layer. The MAC sublayer may control how a computer on the network gains access to the data and permission to transmit it. The LLC layer may control frame synchronization, flow control and error checking.

There are several parameters that the network layer may define to support multicast communications: multicast addressing, dynamic registration and multicast routing.

Multicast Addressing: A network-layer address may be used to communicate with a group of receivers rather than a single receiver. This address is mapped onto layer 2 multicast addresses where they exist. In one embodiment, a multicast address conforming to IP network standards is in the range 224.0.0.0 through 239.255.255.255. This address range is used for the group address or destination address of multicast traffic. The source address of a multicast packet is the unicast source address. Note that a portion of the multicast address space, addresses in the range of 224.0.0.0 through 224.0.0.255, inclusive, may be reserved for the use of routing protocols and other low-level topology discovery or maintenance protocols, such as gateway discovery and group membership reporting. The range of addresses from 224.0.1.0 through 238.255.255.255 may be called globally scoped addresses. The globally scoped address range may be used to multicast data to user devices. In other embodiments a different address range is implemented for multicast traffic.

Dynamic registration: A user device communicates to the sub-network 140 or IP network 142 that it seeks to be a member of a particular group. Without this ability, the network 142 cannot know which networks need to receive traffic for each group. In one example embodiment the Internet Group Membership Protocol (IGMP) is implemented to specify the manner in which a device informs the network that it is to be included as a member of a particular multicast group. IGMP is used to dynamically register individual user devices in a multicast group on a particular LAN or sub-network 140. User devices identify group memberships by sending IGMP messages to their local multicast router (e.g., bypass device 116). Under IGMP, routers may listen to IGMP messages and periodically send out queries to discover which groups are active or inactive on a particular subnet. In addition, some routers may perform IGMP snooping to examine some Layer 3 information in the IGMP packets sent between the user devices and the router. When a router determines that a user device requests membership in a particular multicast group, the router may add the user device's port number to an associated multicast table entry. When the router snoops an IGMP leave group message, it removes the user device's address from the multicast table entry. IGMP snooping is implemented in an embodiment of the PLCS sub-network 140. Bypass devices may inspect data packets transmitted to their downstream user devices to determine if a multicast should be implemented and a backhaul point may inspect data packets transmitted to its downstream MV access devices to determine if a multicast should be implemented.

IGMP snooping may also be performed at the Medium Voltage Repeater (MVR) or Low Voltage Repeater. Upon receiving a multicast packet from one interface (upstream or downstream—which may be the same physical but different logical interface), either in a Unicast or Multicast format, a repeater may need to decide whether it has to repeat the packet to the other interface and how to repeat the packet to the other interface, Unicast or Multicast. This may require the repeater to be able to snoop IGMP packets to determine multicasting membership on one or both of its interfaces.

IGMP Snooping may also be required on the Ethernet switch of a Backhaul Point. In some backhaul point embodiments, the upstream interface of a BP may include an Ethernet switch. The Ethernet switch may be used to provide fiber connectivity to subscribers and to daisy chain multiple backhaul points. IGMP snooping on the Ethernet switch may prevent multicast packets to be sent to unwanted ports and endpoints.

Multicast routing: The sub-network 140 nodes may build data packet distribution trees that allow nodes receiving packets to determine the method for transmitting data packets to receivers (other nodes or user devices). One goal of these packet distribution trees is to ensure that each packet exists only one time on any given path (that is, if there are multiple receivers on a given path, there should only be one copy of the data packet on that path).

According to various embodiments, distance vector multicast routing protocol (DVMRP), multicast open shortest path first (MOSPF) routing, protocol independent multicast (PIM) routing, or any other suitable routing protocol may be implemented at the sub-network 140 communication nodes.

DVMRP includes a technique known as Reverse Path Forwarding. When a router receives a packet, it floods the packet out of all paths except the one that leads back to the packet's source. Doing so allows a data stream to reach all LANs (possibly multiple times) coupled to sub-network 140. If a router is attached to a set of devices (e.g., user devices) or LANs (e.g., LV subnets) that do not want to receive a particular multicast group, the router can send a “prune” message back up the distribution tree to stop transmission of subsequent packets from being addressed to a node where there are no multicast members.

The sub-network 140 may be periodically reflooded to reach any new user devices that want to receive a particular group. There is a direct relationship between the time it takes for a new user device to get the data stream and the frequency of flooding. A unicast routing protocol may be used to determine which interface leads back to the source of the data stream. As a result, the path that the multicast data traffic follows may not be the same as the path that the unicast traffic follows. Because reflooding may occur frequently to identify new members of a group, DVMRP may have significant scaling challenges as the sub-network 140 grows. This limitation may be exacerbated in embodiments in which pruning is not implemented.

MOSPF is an extension to the open shortest path first (OSPF) unicast routing protocol. OSPF works by having routers in a network understand all of the available links in the network. Each OSPF router may calculate routes from itself to all possible destinations. MOSPF works by including multicast information in OSPF link state advertisements and the MOSPF router learns which multicast groups are active on which LANs. MOSPF builds a distribution tree for each source/group pair and computes a tree for active sources sending to the group. The tree state may be cached, and trees are recomputed when a link state change occurs or when the cache times out.

Using MOSPF, the path taken by a multicast data packet depends both on the packet's source address and multicast destination. The path taken between the packet's source and any particular destination group member may be the least cost path available. Cost may be expressed in terms of a link-state metric. For example, if the metric represents delay, a minimum delay path is chosen. MOSPF takes advantage of any commonality of least cost paths to destination group members. However, when members of the multicast group are spread out over multiple networks, the multicast data stream may at times be replicated. This replication is performed as few times as possible (at the tree branches), taking maximum advantage of common path segments. For a given multicast packet, all routers may calculate an identical shortest-path tree.

PIM is compatible with existing unicast routing protocols. PIM supports two different types of multipoint traffic distribution patterns: dense and sparse. Dense mode may be most useful when: senders and receivers are in close proximity to one another; there are few senders and many receivers; the volume of multicast traffic is high; and the stream of multicast traffic is constant. Dense-mode PIM uses Reverse Path Forwarding and generally is compatible with any unicast protocol.

Sparse multicast may be most useful when: there are few receivers in a group; senders and receivers are separated by WAN links; and the type of traffic is intermittent. PIM Sparse Mode (PIM-SM) uses a pull model to deliver multicast traffic. Only networks that have active receivers that have explicitly requested the data are forwarded the traffic. Sparse-mode PIM works by defining a Rendezvous Point. When a sender wants to send data, it first sends to the Rendezvous Point. When a receiver wants to receive data, it registers with the Rendezvous Point. Once the data stream begins to flow from sender to Rendezvous Point to receiver, the routers in the path optimize the path automatically to remove any unnecessary hops. Sparse-mode PIM assumes that no user devices want the multicast traffic unless they specifically ask for it. PIM may be able to simultaneously support dense for some multipoint groups and sparse mode for others.

Layer 2 Power Line Routing Protocol

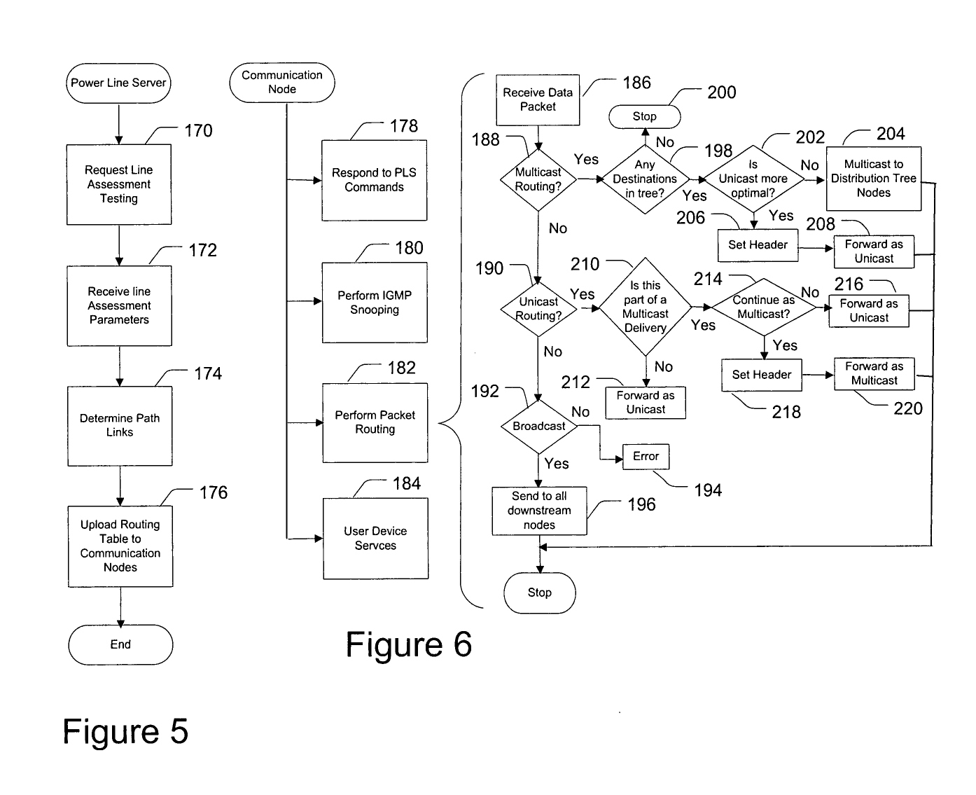

In some embodiments, a power line routing protocol is implemented at level 2 of the 7-layer OSI model. A power line server, as described below in a separate section gathers information about the PLCS sub-network 140 and transmits routing table information to the various communication nodes. FIG. 5 is a flow chart of an example PLS process for setting routing information for the PLCS sub-network 140. At step 170, the PLS 143 sends out a request to one or more communication nodes in PLCS sub-network 140 to return link assessment data. The nodes instructed by the command perform a link assessment. In one embodiment, the links accessed by the instructed node are tested and quality assessment parameters are gathered. The assessment parameters are sent to the PLS 143. For example, the BYTES40 parameter and Get Channel Capabilities responses of the HomePlug protocol provide values for assessing the link quality. At step 172, the assessment parameters are received at the PLS 143. At step 174, the link qualities are evaluated to determine optimal routes between various nodes of the PLCS sub-network, and between a given node and a user device. In this manner optimal or preferred routing may be determined between any two points within the sub-network 140, including any user devices coupled to sub-network 140. In another embodiment, link assessment information may be processed by the communication nodes themselves to determine the optimal or preferred method of routing data, via Unicast or Multicast. In some systems, it may be preferable for the node to make the determination because of the dynamic nature of the power line link quality or scalability issues.

In some instances a less direct path may be defined between two nodes to reduce traffic along the link or to avoid traffic along the link. The link assessment may be performed by one or more nodes in the PLCS sub-network 140. By performing the assessment for all or a part of the sub-network 140, optimal or preferred routing paths may be determined at the PLS 143. At step 176 routing table information may be transmitted to one or more communication nodes for use in routing data packets traversing such nodes.

The level 2 routing information (e.g., MAC addresses) received from the PLS 143 may be combined with the level 3 network information to determine a path at a communication node for forwarding a multicast packet. In a specific embodiment, the routing in the routing table is combined with IGMP snooping to achieve routing over the PLCS sub-network 140 of a multicast data stream. Further, by combining the power line routing protocol with IGMP snooping, an upstream communication node can determine that to reach a specific downstream communication node or user device, it is more optimal to send the data stream as a multicast transmission over a portion of the sub-network 140 and as a unicast transmission over another part of the network.

FIG. 6 shows an example of a sample of high level functions performed by a communication node (e.g., bypass device) in the PLCS sub-network 140. One function 178 is to perform processes responsive to PLS 143 commands. Another function 180 is to perform IGMP snooping to identify user devices that may wish to join a multicast group traversing the node. Another function 182 is to perform packet routing. Another function 184 may include performing user device services, such as described above with regard to the bypass devices 116.

FIG. 6 also shows an example embodiment of a routing process performed at a given node. This example embodiment may implemented in program code stored in memory of the node and executed by a processor. In one embodiment, data packets may be processed as described in FIG. 6 only after the packet is received at the node with the correct address (e.g., MAC or IP address). At step 186 a data packet or stream of related data packets is received. At step 188 the packet header is processed (e.g., inspected, tested, compared, or otherwise processed) to determine whether the data stream is part of a multicast transmission. If not, then at step 190 the packet header is processed to determine whether the data stream is part of a unicast transmission. If not, then at step 192, the packet header is tested to determine whether the data stream is part of a broadcast transmission. If not, then at step 194 error processing occurs, which may simply include discarding the packet. If the transmission is a broadcast packet then at step 196, the data stream is transmitted over the appropriate communication medium (e.g., MV power line, LV power line, wirelessly, etc.) to all downstream nodes as a broadcast data packet. Note that the ordering of steps and the specific steps may vary in alternative embodiments.

When the transmission is a multicast transmission, at step 198 the multicast address is evaluated to determine whether there are any members of the multicast group along the distribution tree of the receiving communication node. If there are no downstream devices that belong to the multicast group, then the multicast transmission terminates. More specifically, the receiving node does not forward the multicast data stream and the process stops at step 200.

When there are downstream user devices in the multicast group, then at step 202 the layer 2 power line routing protocol (L2PLRP) may be accessed to determine if an alternative routing scheme (e.g., unicast) is to be used. For example, if there is only on destination, unicast may be used. If not, then at step 204 the multicast transmission is transmitted on the appropriate communication medium (e.g., MV power line, LV power line, wirelessly, etc.) as a multicast transmission to all downstream nodes in the distribution tree. Note that the data stream may be duplicated at this point to route the data stream along different paths to various user devices (e.g., one path on the MV power line and another path on a LV power line for a bypass device that is also acting as an MV repeater). If the L2PLRP determines that a unicast transmission is more optimal for a portion of the route to one or more user devices, then at step 206, the header may be set to identify a destination address for the unicast transmission. Then at step 208 the data stream is transmitted as a unicast transmission to the destination address.

When step 190 determines that the node has received a unicast transmission, the header is evaluated at step 210 to determine whether the receiving node is the destination node. If not, then the data stream is forwarded at step 212 toward the destination address as a unicast transmission. If the node is the destination node (or services the user device destination), then at step 214 the header is evaluated to determine whether this unicast transmission is part of a multicast transmission being optimized using the L2PLRP. If not, then at step 216 the data stream is forwarded to the downstream device such as the destination user device(s) using unicast transmission(s). If part of a multicast transmission, then at step 218 the header is set back to the multicast address and at step 220 the data stream is forwarded to the downstream nodes in the distribution tree of the node executing this process. Eventually the data stream gets delivered to the user device members of the multicast group for the particular multicast transmission.

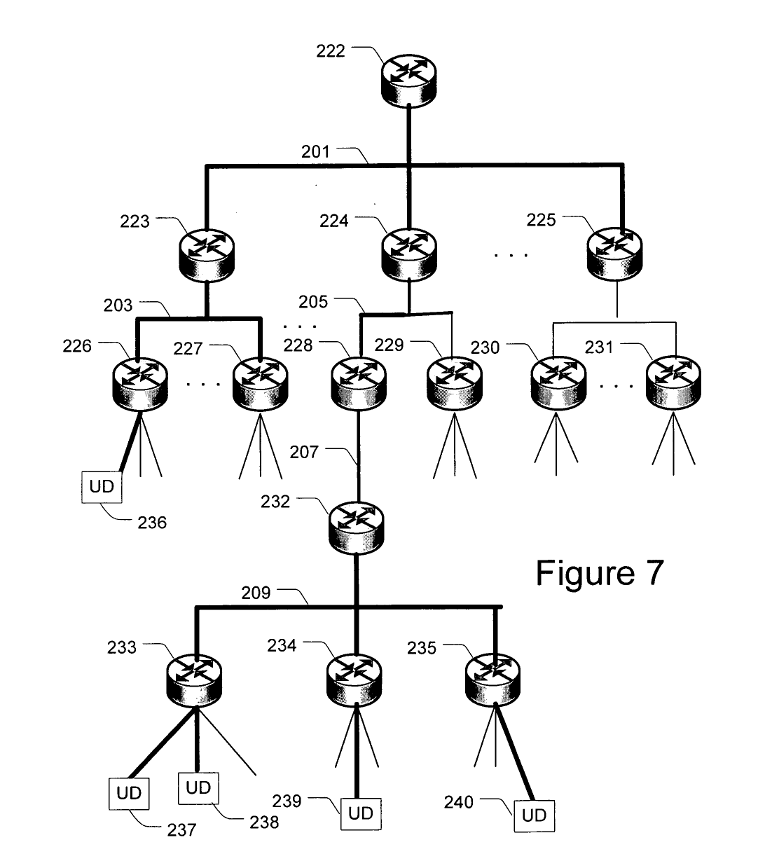

FIG. 7 shows an example routing that occurs for a sample multicast transmission. Communication nodes 222 through 235 are shown, and may be any of one or more types of MV access device, including a backhaul point 220, a repeater, and a bypass device 116. Consider the scenario where a plurality of user devices 236 through 240 join a multicast group. Node 222 receives the data stream and forwards the data stream as a multicast transmission 201 to destination nodes 223-225 in its distribution tree. Node 225 determines that there are no user devices to serve and does not forward the multicast transmission to its downstream nodes 230, 231. Node 223 determines that there are user devices that it serves and forwards the data stream as a multicast transmission 203 to the nodes 226, 227 in its destination tree. In turn node 226 determines that user device 236 is a member and forwards the data stream to the user device 236. Node 227 determines that there are no user devices to serve and does not forward the multicast transmission.

Node 224 receives the multicast transmission from node 222 and determines that there are user devices that it serves that are members. However, node 224 also determines that it is more optimal to forward the data stream to node 232 as a unicast transmission 205 to service the downstream user devices participating in this multicast. Accordingly, node 224 does not send the transmission to all its downstream nodes in its distribution tree. Specifically, in the example shown node 224 does not forward the data stream to node 229. Using the L2PLRP, node 224 sends a unicast transmission of the data stream to node 232. Node 228 is an intermediary node along the path to node 232. Node 228 (e.g., MV repeater) determines that it is not the destination address of the transmission and forwards the unicast transmission 207 to node 232.

Node 232 receives the unicast transmission 207, determines that it is the destination address, and that the transmission is part of a multicast. Node 232 sets the header to forward the data stream as a multicast transmission 209 to the downstream nodes 233, 234, 235 in its destination tree. Node 233 receives the multicast transmission 209 and forwards the data stream to the user devices 237, 238 that it serves (e.g., as a multi-cast data stream or two unicast data streams). Node 234 receives the multicast transmission 209 and forwards the data stream to the user device 239 that it serves (e.g., as a unicast data stream). Node 235 receives the multicast transmission 209 and forwards the data stream to the user device 240 that it serves (e.g., as a unicast data stream). Accordingly, the user devices 236-240 receive the data stream in an efficient economical manner.

In other embodiments the layer 2 PLRP may result in a multicast transmission be rerouted as a multicast transmission along a varied route. In still other embodiments the layer 2 PLRP results in a multicast transmission be rerouted as a broadcast transmission. Accordingly, in some embodiments the multicast transmission may be rerouted as a unicast transmission, a multicast transmission, or a broadcast transmission over all or a portion of the downstream nodes of a given communication node in the PLCS sub-system 140.

The methods described herein may be implemented in computer readable instructions in an encoded medium and executed by a processor in the aggregation point(s), backhaul point(s), bypass devices, MV repeaters, LV repeaters, and/or premises modems. In one embodiment the methods are embedded as instructions carried out in the routers of the backhaul point(s) 120, repeaters, and bypass devices 116 along with other processors in the AP 122 and PLS 143.

MV Access Devices—Backhaul Point

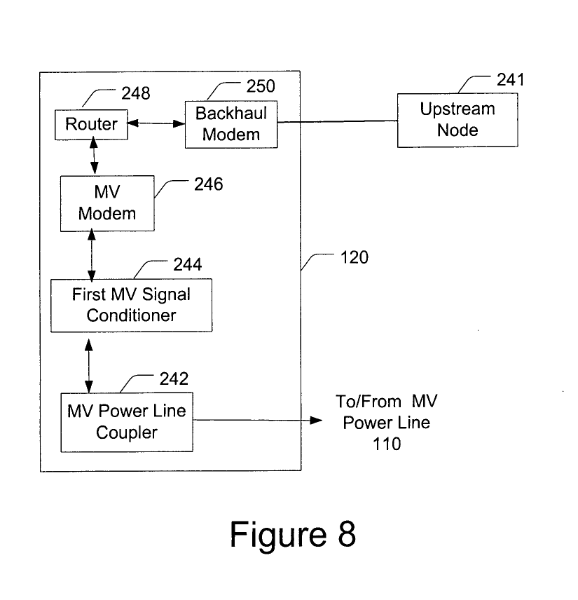

FIG. 8 illustrates one example embodiment of a backhaul point 120 included in the PLCS sub-network 140. The backhaul point 120 is a communication node which moves data between the MV power line 110 and a non-power line medium. Accordingly, the backhaul point 120 links to an upstream node 241 within the PLCS sub-network 140 or external to the PLCS sub-network 140.

To couple data on and off the MV power lines 110, the backhaul point 120 includes an MV power line coupler 242, an MV signal conditioner 244, an MV modem 246, a router 248 and a backhaul modem 250. The MV power line coupler 242 is used to prevent the medium voltage power conducted over the MV line 110 from being conducted to the backhaul point's circuitry, while allowing the communications signal to pass between the backhaul point 120 and the MV power line 110.

The MV power line coupler 242 may be coupled to each phase of the MV power line 110. In some embodiments, however, the coupler 242 may only be physically connected to one phase conductor of the MV power line 110. For example, when communicating along overhead MV power line conductors, data signals sometimes couple across the MV power line conductors. In other words, data signals transmitted on one MV phase conductor may be present on all of the MV phase conductors due to the data coupling between the phase conductors. As a result, the backhaul point 120 need not be physically connected to all three phase conductors of the MV power line cable. In embodiments where coupling between respective conductors is less likely, such as embodiments having underground MV power line cables, it may be preferable for the MV power line coupler 242 to have a separate coupler that is coupled to each of all of the available MV power line phase conductors.

One example of such a coupler is described in U.S. application Ser. No. 10/348,164, Attorney Docket No. CRNT-0143, and entitled “Power Line Coupling Device and Method of Using the Same,” filed Jan. 21, 2003, which is hereby incorporated by reference in its entirety.

The MV signal conditioner 244 may provide filtering (anti-alias, noise, and/or band pass filtering) and amplification. In addition, the MV signal conditioner 244 may provide frequency translation. For example, translation of the frequency is accomplished through the use of a local oscillator and a conversion mixer. Such method and other methods of frequency translation are well known in the art and, therefore, not described in detail.

The MV modem 246 provides data to and receive data from the router 248, and includes a modulator and demodulator. In addition, the MV modem 246 includes one or more functional sub-modules such as an ADC, DAC, memory, source encoder/decoder, error encoder/decoder, channel encoder/decoder, MAC controller, encryption module, and decryption module. These functional sub-modules are omitted in some embodiments, integrated into a modem integrated circuit (chip or chip set) in other embodiments, or integrated peripheral to a modem chip in still other embodiments. In one embodiment, the MV modem 246 is formed, at least in part, by part number INT51X1, which is an integrated power line transceiver circuit incorporating several of the identified submodules, and is manufactured by Intellon, Inc. of Ocala, Fla.

To perform MAC processing, the MV modem 246 adds a MAC header that includes the MAC address of the MV modem 246 as the source address and the MAC address of the destination node (and in particular, the MAC address of the MV modem of the destination node) as the destination MAC address. In addition, the MV modem 246 may also provide channel encoding, source encoding, error encoding, and encryption. For transmitting data onto the MV power lines 110, data is modulated and provided to the DAC to convert the digital data to an analog signal.

In an embodiment, MV communications employ a HomePlug standard (e.g., HomePlug 1.0 or AV). Other protocols may be implemented in other embodiments. In one embodiment a broadband frequency range such as 22-50 MHz, 4-50 MHz, or 30-50 MHz carrier frequency bands may be used. Any of several modulation techniques are used, such as CDMA, TDMA, FDM, and OFDM. In one example embodiment, the MV modem is substantially compliant or compatible with a HomePlug standard (e.g., HomePlug 1.0 or AV) and communicates an OFDM signal.

The router 248 may be embodied as part of a controller and receives and sends data packets, matches data packets with specific messages and destinations, performs traffic control functions, performs usage tracking functions, authorizing functions, throughput control functions and similar routing-relating services. The router 248 may route data from the MV power lines 110 to a backhaul modem 250 and from the backhaul modem 250 onto the MV power lines 110. The router may also recognize commands addressed to the backhaul point 120. The backhaul point 116 may comprises a processor and memory (e.g., a controller) that performs the functions described in the flow charts herein including router functions. A detail description of a router is provided below with respect to the bypass device 116.

The backhaul modem 250 provides communications with the upstream node 241 and, therefore, with the IP network 142. The backhaul modem 250 may comprise a wireless modem, but in other embodiments may include any transceiver suited for communicating through the non-power line telecommunications medium that forms the backhaul link.

MV Access Devices—Bypass Device

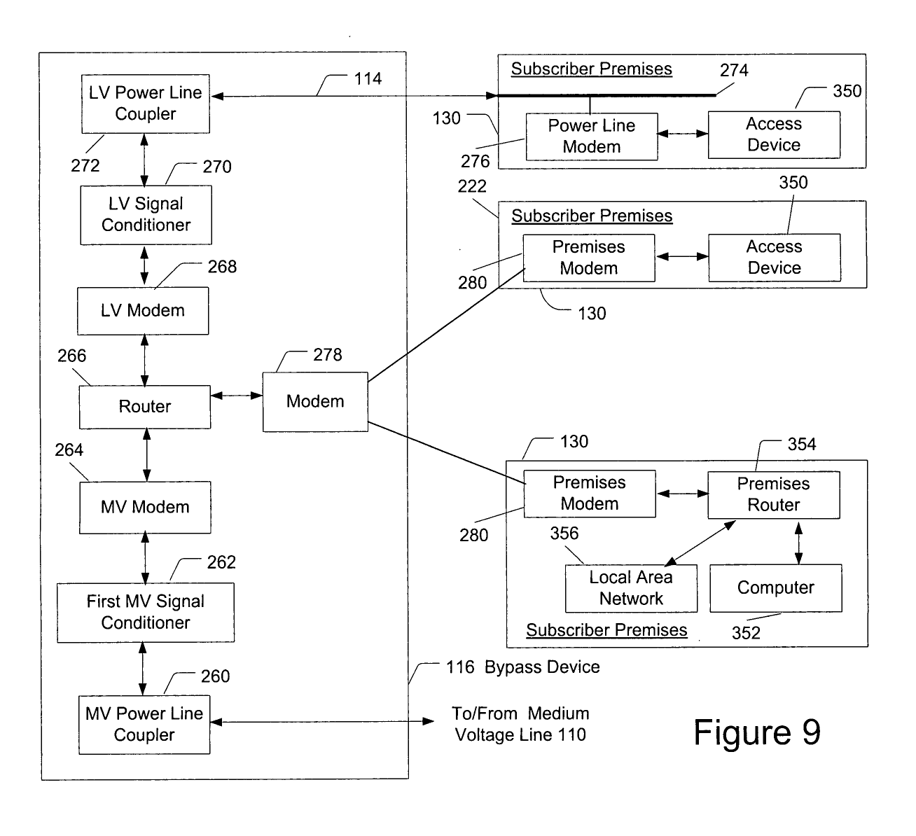

Referring to FIG. 9, the bypass devices 116 provide bi-directional communications between the MV power line 110 and one or more customer premises via first and second data paths. The bypass device may also repeat data packets on the MV power line.

In the illustrated embodiment, the bypass device 116 may include a MV power line coupler 260, an MV signal conditioner 262, an MV modem 264, a router 266, an LV modem 268, an LV signal conditioner 270 and an LV power line coupler 272. The MV power line coupler 260, an MV signal conditioner 262, an MV modem 264 may be substantially the same as those components described for the backhaul point and therefore their description is not repeated here.

In one example, data is moved from the MV power line 110 around the distribution transformer by the bypass device 116 onto the LV power lines 114. The LV power lines 114 extend to customer premises 130 and connect to a low voltage internal power line network 274, (e.g., such as through a circuit breaker panel). The power line modem 276 connects to the internal premises power line network 274 to receive data from and transmit data to the bypass device 116. Subscribers accessing the PLCS may connect to the internal power line network 274 using a power line modem 276. As will be evident to those skilled in the art, and as shown in FIG. 2, the bypass device 116 may be linked to and communicate with devices in a plurality of customer premises 130.

In other embodiments, other communication links to the user devices may be supported, such as a wireless link, a fiber optic link, a telephone line link, an Ethernet link, or a twisted pair link. Such links may be in addition to or instead of a power line link. For any of the fiber optic interface, telephone line interface, Ethernet interface, twisted pair interface and wireless interface, an appropriate modem 278 is included in or in the vicinity of the bypass device 116 and another compatible modem 280 at the customer premises 130.

The router 266 may be embodied as part of a controller and performs routing functions. For example, router 266 may perform routing functions using layer 3 data (e.g., IP addresses), layer 2 data (e.g., MAC addresses), or a combination of layer 2 and layer 3 data (e.g., a combination of MAC and IP addresses). The router for example may perform the multicast method steps for a given bypass device 116 and also other functions (e.g., see FIG. 6) for controlling the operation of the bypass device 116 functional components. In other embodiments, the bypass device 116 performs layer 2 bridging.

In one embodiment the router 266 uses a table (e.g., a routing table) and programmed routing rules stored in memory to determine the next destination of a data packet. The table is a collection of information and includes information relating to which interface (e.g., medium voltage or low voltage) leads to particular groups of addresses (such as the addresses of the user devices connected to the customer LV power lines), priorities for connections to be used, and rules for handling both routine and special cases of traffic (such as voice packets and/or control packets).

The router 266 detects routing information, such as the destination address (e.g., the destination IP address) and/or other packet information (such as information identifying the packet as voice data), and matches that routing information with rules (e.g., address rules) in the table. The rules may indicate that packets in a particular group of addresses should be transmitted in a specific direction such as through the LV power line 114 (e.g., if the packet was received from the MV power line and the destination IP address corresponds to a user device connected to the LV power line), repeated on the MV line (e.g., if the bypass device 230 is acting as a repeater), or be ignored (e.g., if the address does not correspond to a user device connected to the LV power line or to the bypass device 230 itself).

As an example, the table may include information such as the IP addresses (and potentially the MAC addresses) of the user access devices, the MAC addresses of the wireless modems 278, the premises modems 280, 276, the MV modem 264, the LV modem 268 and other modems communicating with the bypass device 116. Based on the destination IP address of the packet (e.g., an IP address), the router 266 passes the packet to the MV modem 264 (for transmission on the MV power line 110), to modem 278 (for transmission via the wireless link or wired link); or to LV modem 269 (for transmission on the LV power lines 114). Alternately, if the IP destination address of the packet matches the IP address of the bypass device 116 the bypass device 116 may process the packet as a request for data or other command.

With regard to the bypass device 116, the LV power line coupler 272, LV signal conditioner 270 and LV modem 268 are now described. The LV power line coupler 272 couples data to and from the LV power line 114. The coupler 272 also can draw power from the LV power line 114 to power at least a portion of the bypass device 116.

In one embodiment the LV coupler 272 is an inductive coupler, such as a toroidal coupling transformer, or is a capacitive coupler. In another embodiment, the conductors from the bypass device 116 may simply have leads connected to the two LV hot conductors. The signals entering the bypass device 116 are processed with conventional transient protection circuitry, which is well-known to those skilled in the art. The data signals “ride on” (i.e., are additive of) the low frequency power signal the 120V 60 Hz voltage signal. Consequently, it is desirable to remove the low frequency power signal, but to keep the data signals for processing. This may be accomplished by the voltage translation circuitry. The voltage translation circuitry may include a high pass filter to remove the low frequency power signal and may also (or instead) include other conventional voltage translation circuitry. The data signals also are processed with impedance translation circuitry, which is well-known in the art.

The LV signal conditioner 270 conditions data signals using filtering, automatic gain control, and other signal processing to compensate for the characteristics of the LV power line 114. For example, the data signal may be filtered into different bands and processed.

One terminal of the LV signal conditioner 270 is coupled to the LV power coupler 272, and another terminal is coupled to the LV modem 268. The LV modem 268 includes a modulator and a demodulator. The LV modem 268 also includes one or more additional functional sub-modules such as an Analog-to-Digital Converter (ADC), Digital-to-Analog Converter (DAC), a memory, source encoder/decoder, error encoder/decoder, channel encoder/decoder, MAC (Media Access Control) controller, encryption module, and decryption module. In various embodiments, one or more functional sub-modules are omitted, integrated into a modem integrated circuit (chip or chip set), or integrated peripherally to a modem chip. In the present example embodiment, the LV modem 268 is formed, at least in part, by part number INT51X1, which is an integrated power line transceiver circuit incorporating most of the above-identified sub-modules, and which is manufactured by Intellon, Inc. of Ocala, Fla.

The LV modem 268 passes data from the LV signal conditioner to the router 266, and passes data received from the router 266 to the LV signal conditioner 270. The LV modem 268 provides encryption and decryption, source coding and decoding, error coding and decoding, channel coding and decoding, and media access control (MAC) all of which are known in the art and, therefore, not explained in detail here.

With respect to MAC processing, however, the LV modem 268 may examine information in the packet to determine whether the packet should be ignored or passed to the router 266. For example, the LV modem 268 may compare the destination MAC address of the packet with the MAC address of the LV modem 268 (which is stored in the memory of the LV modem 268). If there is a match, the LV modem 268 removes the MAC header of the packet and passes the packet to the router 266. If there is not a match, the packet may be ignored.

User Devices

A variety of user devices 350 can access the hybrid communication sub-network 140 from a subscriber's premises 148. Examples of user devices 350 that may connect to the sub-network 140 include Voice-over IP endpoints, game systems, digital cable boxes, computers 352, routers 354, local area networks 356, power meters, security systems, alarm systems (e.g., fire, smoke, carbon dioxide, etc.), stereo systems, televisions, and fax machines.

LV Power Line Link

For convenience, the system will be described using the HomePlug standard (which may include HomePlug 1.0 or HomePlug A/V), but other standards and schemes may be used for communication along the low voltage power line. Because multiple PLMs 274 may be interconnected by low voltage lines, the line is shared and data transmission is managed to avoid transmission collisions.

The premises power line network 274 includes various electrical circuits at the customer's premises 130 which distribute power and data signals within the customer premises. A power customer draws power on demand by plugging a device into a power outlet. In a similar manner, a hybrid sub-network 140 subscriber plugs the power line modem 276 into a power outlet to form a digitally communication path to and from user devices 350. The communication signals are carried over the residential power wiring.

The PLM 276 can have a variety of interfaces for customer data appliances. For example, a PLM 276 can include a RJ-11 Plain Old Telephone Service (POTS) connector, an RS-232 connector, a USB connector, a 10 Base-T connector, RJ-45 connector, and the like. In this manner, a customer can connect a variety of user devices 350 to the PLCS. Further, multiple PLMs 276 can be plugged into power outlets throughout the customer premises, with each PLM 276 communicating over the same wiring internal to the customer premises.

The PLM 276 can be connected to (or integrated into) any device capable of supplying data for transmission (or for receiving such data) including, but not limited to a computer, a telephone, a telephone answering machine, a fax, a digital cable box (e.g., for processing digital audio and video, which may then be supplied to a conventional television and for transmitting requests for video programming), a video game, a stereo, a videophone, a television (which may be a digital television), a video recording device, a home network device, a utility meter, or other device. The functions of the PLM 276 may be integrated into a smart utility meter such as a gas meter, electric meter, water meter, or other utility meter to provide automated meter reading (AMR).

Power Line Server

As discussed, some embodiments of the PLCS also include a power line server (PLS) 143 (see FIG. 2) that is a computer system with memory for storing a database of information about the sub-network 140. The PLS 143 includes a network element manager (NEM) that monitors and controls the sub-network 140. The PLS allows network operations personnel to provision users and network equipment, manage customer data, and monitor system status, performance and usage. The PLS may reside at a remote operations center to oversee a group of communication devices via the IP network 142.

The PLS may provide an IP network identity to the network devices (e.g., backhaul modem 250, MV modem 246, 264, LV modem 268, routers 248, 266, modems 278, premises modems 280, power line modems 276, and LV and MV repeaters) by assigning each device an IP address and storing the IP address and other device identifying information (e.g., the device's location, address, serial number, etc.) in its memory. In addition, the PLS may approve or deny user devices authorization requests, command status reports and measurements from the bypass devices, repeaters, and backhaul points, and provide application software upgrades to the communication devices (e.g., bypass devices, backhaul points, repeaters, and other devices).

By collecting electric power distribution information and interfacing with utilities' back-end computer systems, the PLS provides enhanced distribution services such as automated meter reading, outage detection, load balancing, distribution automation, Volt/Volt-Amp Reactance (Volt/VAr) management, and other similar functions.

The PLS also may be connected to one or more back haul points 120, and/or core routers 248, 266 directly or through the IP network 142 and therefore can communicate with any of the bypass devices 116, routers 248, 266, user devices 350, backhaul points 120, repeaters and other network elements. The PLS may also transmit subscriber information, such as whether a particular data service is enabled for a user (e.g., voice), the level of service for each data service for a user (e.g., for those data services having more than one level of service), address information (e.g., IP address and/or media access control (MAC) addresses for devices) of the subscribers, and other information.

In an alternate embodiment, the backhaul point 120 may be communicatively coupled to one or more nodes via a fiber optic cable, coaxial cable, or wirelessly instead of a via the MV power line. Multicasting may be employed on the LV power lines, and/or other links. Additionally, in some PLCS, user devices and communication nodes may be configured to multicast and/or broadcast in the upstream direction. Finally, where encryption of data is used, devices receiving a multicast or broadcast transmission may all employ the same encryption key. The multicast transmissions described herein have multitude of applications such as transmitting data streams of audio/video programming such, for example, as live events (e.g., sporting events, radio programming) or other programming starting at a particular time (e.g., television programming, on demand programming, movies, radio programming). Broadcast transmission may used to communicate alarms, alerts, and commands to turn off or turn on load control devices (i.e., to turn on or off power to customer premises and/or devices therein).

It is to be understood that the foregoing illustrative embodiments have been provided merely for the purpose of explanation and are in no way to be construed as limiting of the invention. Words used herein are words of description and illustration, rather than words of limitation. In addition, the advantages and objectives described herein may not be realized by each and every embodiment practicing the present invention. Further, although the invention has been described herein with reference to particular structure, materials and/or embodiments, the invention is not intended to be limited to the particulars disclosed herein. Rather, the invention extends to all functionally equivalent structures, methods and uses, such as are within the scope of the appended

Those skilled in the art, having the benefit of the teachings of this specification, may affect numerous modifications thereto and changes may be made without departing from the scope and spirit of the invention.

What is claimed is:

1. A method of communicating data with a plurality of devices using a power line communication system that communicates over a power line, comprising:
receiving first data; and
transmitting said first data in a multicast transmission over the power line to a plurality of devices.

2. The method of claim 1, further comprising receiving second data in a unicast transmission via the power line from one of said plurality of devices.

3. The method of claim 2, further comprising transmitting the second data over medium voltage power lines.

4. The method of claim 1, further comprising:
receiving said first data at one of the plurality of devices; and
transmitting said first data in a multicast transmission to a plurality of user devices.

5. The method of claim 4, wherein transmitting said first data in a multicast transmission to a plurality of user devices comprises transmitting said first data wirelessly.

6. The method of claim 4, wherein said transmitting said first data in a multicast transmission to a plurality of user devices comprises transmitting said first data over a low voltage power line.

7. The method of claim 1, further comprising:
receiving said first data at a first device;
transmitting said first data in a unicast packet over the power lines from said first device to a second device; and
transmitting said first data in a multicast transmission from said second device to a plurality of user devices located among one or more premises.

8. The method of claim 1, wherein the power line comprises a medium voltage power line.

9. The method of claim 1, further comprising
receiving said first data at one of the plurality of devices;
selecting an interim destination for routing the first data; and
transmitting the first data in a unicast packet from the first device to said interim destination.

10. The method of claim 1, further comprising:
receiving said first data at one of the plurality of devices; and
transmitting said first data in a broadcast transmission to a plurality of user devices located among one or more premises.

11. The method of claim 1, further comprising
receiving second data; and
transmitting said second data in a broadcast transmission over the power line to a plurality of devices.

12. The method of claim 1, further comprising
receiving a request to join a group from a user device; and
adding said user device to the group.

13. The method of claim 1, further comprising:
receiving said first data at a first device;
determining whether said first data is to be transmitted via a unicast transmission or a multicast transmission; and
transmitting said first data in accordance with said determination.

14. The method of claim 1, further comprising:
determining whether said first data is to be transmitted via a unicast transmission or a multicast transmission; and
wherein said transmitting of said first data in a multicast transmission is performed in accordance with said determination.

15. A method for using a power line communication system having a medium voltage power line, comprising:
receiving first data from the medium voltage power line;
transmitting the first data in a multicast transmission to a plurality of user devices; and
receiving second data in a unicast data packet from a user device.

16. The method of claim 15, wherein said transmitting the first data comprises transmitting over a wireless link.

17. The method of claim 15, wherein said transmitting the first data comprises transmitting over a low voltage power line.

18. The method of claim 15, wherein at least some of the plurality of user devices are located in different customer premises.

19. The method of claim 15, further comprising transmitting the second data over the medium voltage power line.

20. The method of claim 15, wherein said first data is received as a broadcast transmission.

21. The method of claim 15, wherein said first data is received as a multicast transmission.

22. The method of claim 15, wherein said first data is received as a unicast transmission.

23. The method of claim 15, wherein said first data is received from a repeating device.

24. The method of claim 15, further comprising
receiving second data from the medium voltage power line; and
transmitting the second over the medium voltage power line.

25. The method of claim 15, further comprising:
determining whether said first data is to be transmitted via a unicast transmission or a multicast transmission; and
wherein transmitting said first data in a multicast transmission is performed in accordance with said determination.

26. The method of claim 15, further comprising
receiving a request to join a group from one of said plurality of user devices; and
adding said user device to the group.

27. The method of claim 26, further comprising:
transmitting information of said request over the medium voltage power line; and
receiving a response to said transmitted information; and
wherein said adding said user is performed in response to receiving said response.

28. A method of using a device to communicate data over a medium voltage power line with a plurality of devices, comprising:
receiving first data;
transmitting said first data to one of the plurality of devices via a data packet addressed for only said one device;
receiving second data; and
transmitting said second data to a subset of the plurality of devices via a single data stream.

29. The method of claim 28, wherein the first data and the second data are received via the medium voltage power line.

30. The method of claim 28, wherein the first data and the second data are transmitted over the medium voltage power line.

31. The method of claim 28, further comprising:
determining whether said second data is to be transmitted via a unicast transmission or a multicast transmission; and
wherein transmitting said second is performed in accordance with said determination.

32. The method of claim 28, further comprising
receiving a request to join a group from one of said plurality of devices; and
adding said device to the group.

33. The method of claim 28, further comprising:
performing link assessments for at least two power line communication paths;
determining routing information based, at least in part, on said link assessments.
